(19) United States
(12) Patent Application Publication
(10) Pub. No.: US 2025/0289358 A1
(43) Pub. Date: Sep. 18, 2025

(54) DUAL GEAR AND PAWL OF TIE DOWN SYSTEM

(71) Applicant: HYUNDAI TRANSLEAD, San Diego, CA (US)

(72) Inventors: Loc Bui, San Diego, CA (US); Kaitlyn Paresa, San Diego, CA (US); Weilun Chang, San Diego, CA (US)

(21) Appl. No.: 18/642,284

(22) Filed: Apr. 22, 2024

Related U.S. Application Data
(60) Provisional application No. 63/566,100, filed on Mar. 15, 2024.

(51) Int. Cl. B60P 7/08; B60P 3/079

(52) U.S. Cl. CPC B60P 7/0846; B60P 3/079

(57) ABSTRACT

A dual-gear winch includes: a winch plate; a gear assembly coupled to the winch plate and configured to rotate with respect to the winch plate; a support bracket assembly coupled to the winch plate, the support bracket assembly including a hook; and a winch pawl including a slot, wherein the winch pawl is positioned to move the slot to accept the hook and to disengage from the gear assembly, or wherein the winch pawl is positioned to move the slot out and away from the hook and to engage the gear assembly.

### CROSS-REFERENCE TO RELATED APPLICATIONS

This application claims the benefit of priority under 35 U.S.C. § 119(e) of U.S. Provisional Patent Application No. 63/566,100, filed Mar. 15, 2024, entitled “Dual Gear and Pawl of Tie Down System.” The disclosure of the above-referenced application is incorporated herein by reference.

### BACKGROUND

### Field of the Invention

The present disclosure relates generally to a tie down system, and more specifically, to dual gear and pawl of the tie down system.

### Background

A car hauler trailer requires reliable tie-down or securement systems for its load. The securement systems may include designs for gears, springs and pawls. Accordingly, the car hauler trailer may have winches attached to the side to strap the vehicle(s) down to the trailer. A winch may include a ratchet mechanism to enable straps to be tightened and locked to keep the vehicle in place while the trailer is in transit.

FIG. 1 shows a simplified diagram of a ratchet mechanism 100 including a gear 110, a pawl 120, and a spring 130. In FIG. 1, the pawl 120 acts as a stopper for the gear 110 to prevent the movement of the gear 110 in a clockwise direction. In some industries and products, the pawl 120 may apply a force to the gear 110 due to the gravity. However, the ratchet mechanism 100 used for the car hauler trailer cannot rely solely on the force of gravity because the winch is not always in an orientation where gravity acts on the pawl 120 in the correct direction. Thus, the pawl 120 must be spring-loaded. The conventional ratchet mechanisms used in the car hauler trailers have used springs to keep the pawl engaged with the gear. However, the springs used in a configuration to keep the pawl engaged often fail and need to be replaced.

### SUMMARY

The present disclosure describes a dual-gear winch using pawl and support bracket assembly along with appropriately-placed springs to engage or disengage a gear assembly.

In one implementation, a dual-gear winch is disclosed. The dual-gear winch includes: a winch plate; a gear assembly coupled to the winch plate and configured to rotate with respect to the winch plate; a support bracket assembly coupled to the winch plate, the support bracket assembly including a hook; and a winch pawl including a slot, wherein the winch pawl is positioned to move the slot to accept the hook and to disengage from the gear assembly, or wherein the winch pawl is positioned to move the slot out and away from the hook and to engage the gear assembly.

In another particular implementation, a winch is disclosed. The winch is attached to a plate and includes: a gear assembly coupled to and configured to rotate with respect to the plate; a winch pawl coupled to and rotated to engage or disengage from the gear assembly; a support bracket assembly coupled to the plate, the support bracket assembly including a hook to keep the winch pawl disengaged from the gear assembly; and a torsion spring configured to keep the winch pawl engaged to the gear assembly.

Other features and advantages of the present disclosure should be apparent from the present description which illustrates, by way of example, aspects of the present disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 shows a simplified diagram of a ratchet mechanism including a gear, a pawl, and a spring;

FIG. 2A is a diagram showing a car hauler trailer including winches attached to the side of the trailer in accordance with one implementation of the present disclosure;

FIG. 2B is a detailed view of a securement system including a winch shown in an inset diagram in accordance with one implementation of the present disclosure;

FIG. 3A is an isometric view of a winch including dual gears, pawl, and springs in accordance with one implementation of the present disclosure;

FIG. 3B shows the winch in the disengaged mode in accordance with one implementation of the present disclosure;

FIG. 3C shows the winch in the engaged mode in accordance with one implementation of the present disclosure;

FIG. 3D is an exploded view of the winch including dual gears, pawl, and springs in accordance with one implementation of the present disclosure; and

FIG. 3E is a top view of the winch to show in detail the operation of the winch pawl in combination with the springs in accordance with one implementation of the present disclosure.

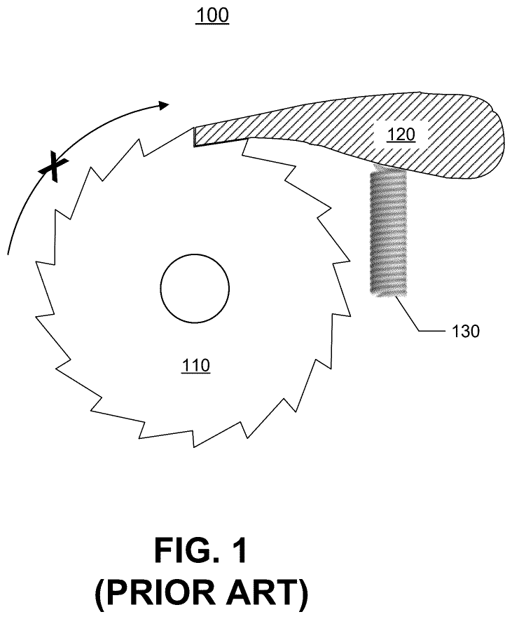

### DETAILED DESCRIPTION

As stated above, conventional ratchet mechanisms used in the securement systems of car hauler trailers have used springs to keep the pawl engaged with the gear. However, the springs used in the conventional ratchet mechanisms often fail and need to be replaced. To improve the design of the existing securement systems, certain implementations of the present disclosure provide for using pawl and support bracket assembly along with appropriately-placed springs to engage or disengage the winch gear assembly.

Accordingly, after reading this description it will become apparent how to implement the present disclosure in various implementations and applications. Although various implementations of the present disclosure will be described herein, it is understood that these implementations are presented by way of example only, and not limitation. As such, this detailed description of various implementations should not be construed to limit the scope or breadth of the present disclosure.

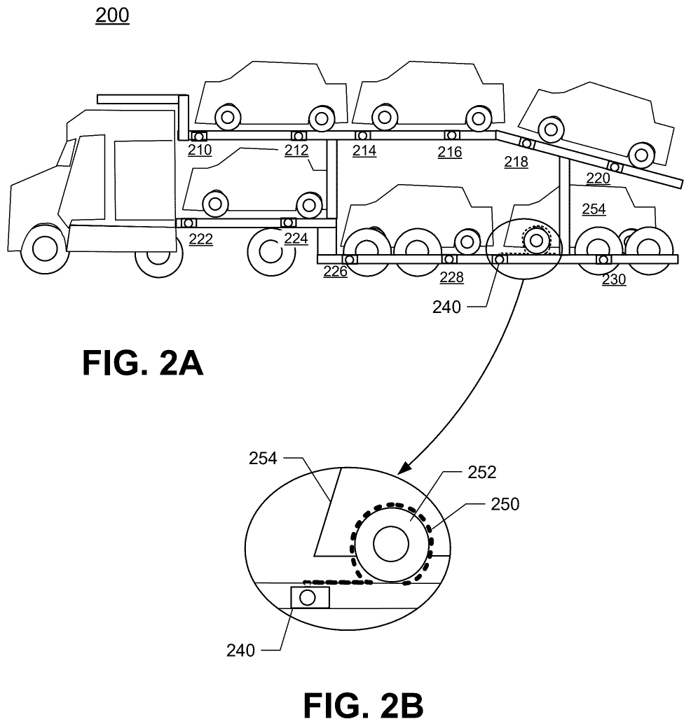

FIG. 2A is a diagram showing a car hauler trailer 200 including winches 210-230, 240 attached to the side of the trailer 200 in accordance with one implementation of the present disclosure.

FIG. 2B is a detailed view of a securement system including a winch 240 shown in an inset diagram in accordance with one implementation of the present disclosure. The winch 240 is used to tighten and lock the strap 250 around the tire 252 of the vehicle 254 to keep the vehicle in place (i.e., in a tie-down system) while the trailer is in transit.

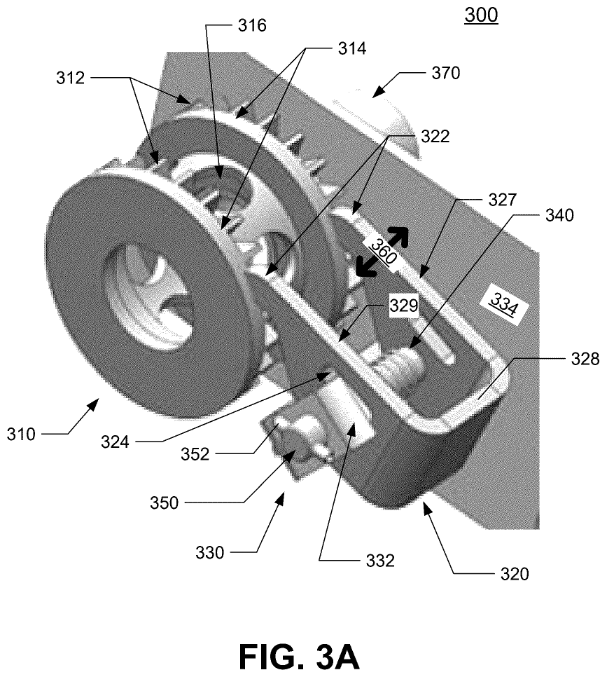

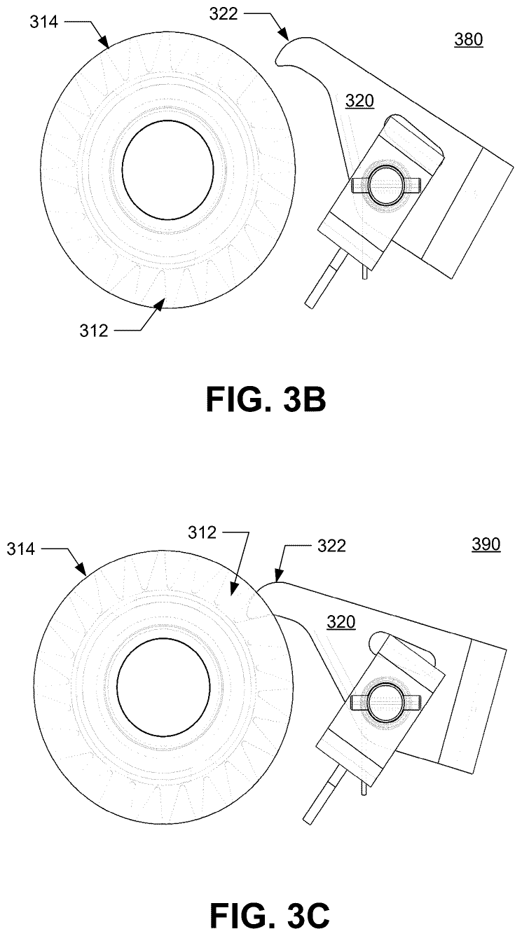

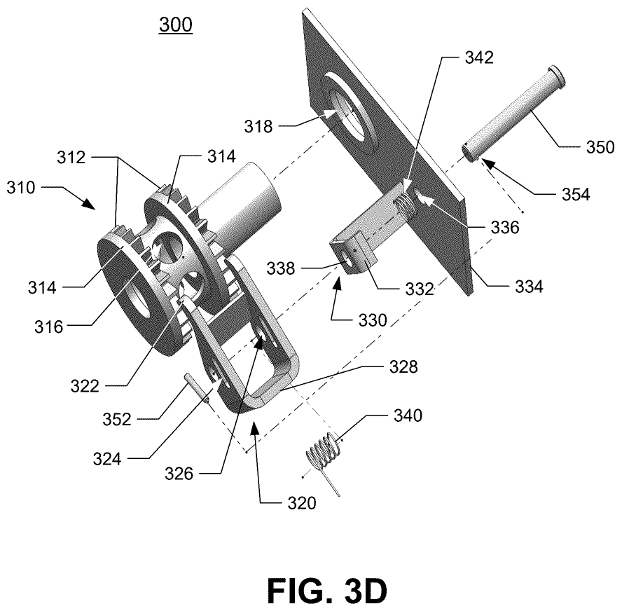

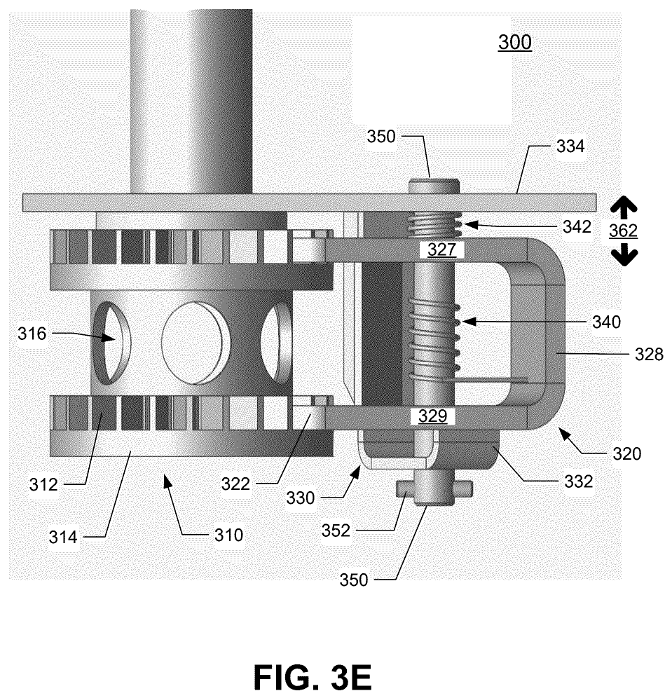

FIG. 3A is an isometric view of a winch 300 including dual gears, pawl, and springs in accordance with one implementation of the present disclosure. In FIG. 3A, the winch 300 includes a winch gear assembly 310 and a winch pawl 320 to engage or disengage the winch gear assembly 310. The winch 300 also includes a winch support bracket assembly 330, a winch plate 334, and spring/pin components. In one implementation, the winch support bracket assembly 330 attaches to the winch plate 334 and includes a hook 332 and a bracket hole 338. In one implementation, the spring/pin components include a torsion spring 340, a compression spring 342 (shown in FIGS. 3D and 3E), a steel pin 350 (e.g., a hat-shaped steel pin), and a spring pin 352.

In the illustrated implementation of FIG. 3A, the winch gear assembly 310 includes dual-gear teeth 312 and pawl resting surfaces 314. In FIG. 3, the winch gear assembly 310 also includes holes 316 in between the teeth 312 for turning the assembly 310 with a winch bar. Turning the assembly 310 also turns a winch mandrel 370 which includes a slot to slide the strap 250 through it and allow the strap 250 to tie down the tire 252 of the vehicle 254. In FIG. 3, winch pawl 320 includes tips 322, a slot 324, pin holes 326 (see FIG. 3D), sides 327, 329, and rear end 328.

In one implementation, the tips 322 of the winch pawl 320 engage the dual-gear teeth 312 when the strap 250 is locked around the tire 252 of the vehicle 254 with tension (i.e., in a tie-down system), and disengages or retracts away from the dual-gear teeth 312 when operating to tighten or loosen the strap 250 by inserting a winch bar into the holes 316 and turning the component 310 with the winch bar.

In one implementation, when the rear end 328 of the winch pawl 320 is pushed down and the tips 322 are lifted up (in an indicated direction 360), the compression spring 342 (shown in FIGS. 3D and 3E) pushes the pawl 320 out (in an indicated direction 362 away from the winch plate 334 as shown in FIG. 3E). When the pawl 320 is pushed up and out, the winch pawl 320 is in a disengaged mode and allows the hook 332 of the winch support bracket assembly 330 to insert into the slot 324 to keep the winch pawl 320 in the disengaged mode. In the disengaged mode, the tips 322 of the winch pawl 320 rest on or above the pawl resting surfaces 314 and allow the winch gear assembly 310 to be rotated freely. In the disengaged mode, the hook 332 of the assembly 330 also inserts into the slot 324 to keep the winch pawl 320 in the disengaged mode until the operator pushes the winch pawl 320 toward the winch plate 334 to moves it out of the disengaged mode. Further, by pushing the winch pawl 320 toward the winch plate 334 (and putting a force on the compression spring 342), the slot 324 is moved out of the hook 332 and the tips 322 of the winch pawl 320 drop and re-engage the teeth 312 in an engaged mode. The winch pawl 320 drops down into the engaged mode in the indicated direction 360 by the torsion spring 340. FIG. 3A shows the engaged mode.

FIG. 3B shows the winch in the disengaged mode 380 in accordance with one implementation of the present disclosure. In this mode 380, the tip 322 of the winch pawl 320 is shown resting above the pawl resting surface 314 and disengaged from the teeth 312.

FIG. 3C shows the winch 300 in the engaged mode 390 in accordance with one implementation of the present disclosure. In this mode 390, the tip 322 of the winch pawl 320 is shown inserted in between the teeth of the gear 312 (i.e., engaged in the teeth 312).

FIG. 3D is an exploded view of the winch 300 including dual gears, pawl, and springs in accordance with one implementation of the present disclosure. In FIG. 3D, the winch 300 includes the winch gear assembly 310 and the winch pawl 320 to engage or disengage the winch gear assembly 310. The winch 300 also includes the winch support bracket assembly 330, the winch plate 334, and spring/pin components. The winch plate 334 includes a first plate hole 336 and a second plate hole 318. The winch gear assembly 310 inserts through the second plate hole 318 of the winch plate 334.

As shown in FIG. 3D, the winch support bracket assembly 330 attaches to the winch plate 334 and includes the hook 332. The spring/pin components include the torsion spring 340 (which is disposed between two sides of the winch pawl 320 during the operation of the winch 300), the compression spring 342 (which is disposed between the winch pawl 320 and the winch plate 334 during the operation of the winch 300), the steel pin 350, and a spring pin 352. In one implementation, the steel pin 350 inserts through the first plate hole 336 of the winch plate 334, the compression spring 342, a pin hole 326 on a first side 327 of the winch pawl 320, the torsion spring 340 disposed between the first and second sides 327, 329, a pin hole 326 on a second side 329 of the winch pawl 320, and the bracket hole 338 of the winch support bracket assembly 330. Once the steel pin 350 pushes out of the bracket hole 338, the spring pin 352 is inserted into a side hole 354 of the steel pin 350 to secure the winch pawl 320 onto the winch plate 334.

FIG. 3E is a top view of the winch 300 to show in detail the operation of the winch pawl 320 in combination with the springs 340, 342 in accordance with one implementation of the present disclosure. FIG. 3E shows the winch 300 in the engaged mode.

In one implementation, when the winch 300 is initially in the engaged mode, and the rear end 328 of the winch pawl 320 is pushed down (i.e., putting a force on the torsion spring 340 into the paper) to lift up the tips 322, the compression spring 342 pushes the pawl 320 out (in the indicated direction 362). Thus, when the pawl 320 is pushed up and out, the winch pawl 320 is pushed into the disengaged mode and allows the hook 332 of the winch support bracket assembly 330 to insert into the slot 324 to keep the winch pawl 320 in the disengaged mode. In the disengaged mode, the tips 322 of the winch pawl 320 rest on or above the pawl resting surfaces 314 and allow the winch gear assembly 310 to be rotated freely.

In one implementation, when the winch 300 is initially in the disengaged mode, and the winch pawl 320 is pushed in (in the indicated direction 362) toward the winch plate 334 (i.e., putting a force on the compression spring 342), the slot 324 is moved out of the hook 332 and the tips 322 of the winch pawl 320 drop and re-engage the teeth 312 in an engaged mode. The winch pawl 320 drops down into the engaged mode by the force applied by the torsion spring 340 onto the rear end 328 of the winch pawl 320. This motion puts the winch 300 into the engaged mode again.

FIG. 3E also shows a top view of the steel pin 350 inserted through the winch plate 334, the compression spring 342, a first side 327 of the winch pawl 320, the torsion spring 340, a second side 329 of the pawl 320, and the bracket hole 338 (shown in FIG. 3D) of the winch support bracket assembly 330. As described before, once the steel pin 350 pushes out of the bracket hole 338, the spring pin 352 is inserted into the side hole 354 of the steel pin 350 to secure the winch pawl 320 onto the winch plate 334.

In one implementation, the benefits of the winch 300 are described below:
1) enable distribution of the force and substantial lowering of the risk of a winch failure by using the dual-gear and dual-pawl-tip configuration to generate two points of contact;
2) enable easy movement of the winch pawl using torsion and compression springs along with the slot for inserting the hook of the bracket assembly;
3) lower maintenance cost by using inexpensive and widely available springs for keeping the pawls engaged and disengaged.

In one particular implementation, a dual-gear winch 300 is disclosed. The dual-gear winch includes: a winch plate 334; a gear assembly 310 coupled to the winch plate 334 and configured to rotate with respect to the winch plate 334; a support bracket assembly 330 coupled to the winch plate 334, the support bracket assembly 330 including a hook 332; and a winch pawl 320 including a slot 324, wherein the winch pawl 320 is positioned to move the slot 324 to accept the hook 332 and to disengage from the gear assembly 310, or wherein the winch pawl 320 is positioned to move the slot 324 out and away from the hook 332 and to engage the gear assembly 310.

In one implementation, the winch plate 334 includes at least first hole 318 and second hole 336. In one implementation, the gear assembly 310 is coupled to the winch plate 334 through the first hole 318 of the winch plate 334 and is configured to rotate with respect to the winch plate 334. In one implementation, the dual-gear winch 300 further includes a steel pin 350 having a proximal end and a distal end, wherein the distal end is inserted through the second hole 336 of the winch plate 334, and includes a side hole 354. In one implementation, the winch pawl 320 further includes tips 322, a first side 327, a second side 329, a rear end 328, and a pair of holes 326, wherein the steel pin 350 passes through the pair of holes 326 of the winch pawl 320. In one implementation, the dual-gear winch 300 further includes a compression spring 342 inserted through the steel pin 350 and disposed between the winch plate 334 and the first side 327 of the winch pawl 320, wherein the compression spring 342 is configured to push the winch pawl 320 out and away from the winch plate 334, when the rear end 328 is pushed down while the tips 322 of the winch pawl 320 are engaging the gear assembly 310. In one implementation, the dual-gear winch 300 further includes a torsion spring 340 inserted through the steel pin 350 and disposed between the first side 327 and the second side 329 of the winch pawl 320, wherein the torsion spring 340 is configured to move the rear end 328 of the winch pawl 320 up and to drop the tips 322 down to engage the gear assembly 310, when the winch pawl 320 is pushed toward the winch plate 334 while the tips 322 of the winch pawl 320 are disengaged from the gear assembly 310. In one implementation, the support bracket assembly 330 further includes a bracket hole 338, through which the steel pin 350 passes. In one implementation, the dual-gear winch 300 further includes a spring pin 352 configured to insert into the side hole 354 of the steel pin 350 to secure the winch pawl 320 onto the winch plate 334. In one implementation, the gear assembly 310 includes dual-gear teeth 312 and resting surfaces 314. In one implementation, the winch pawl 320 further includes tips 322, which rest on or above the resting surface 314 when the winch pawl 320 is disengaged from the gear assembly 310, and which drop on the teeth 312 when the winch pawl 320 is engaging the gear assembly 310. In one implementation, the gear assembly 310 further includes mandrel holes 316 in between the dual-gear teeth 312 for turning the gear assembly 310 with a winch bar.

In another particular implementation, a winch 300 is disclosed. The winch 300 is attached to a plate 334 and includes: a gear assembly 310 coupled to and configured to rotate with respect to the plate 334; a winch pawl 320 coupled to and rotated to engage or disengage from the gear assembly 310; a support bracket assembly 330 coupled to the plate 334, the support bracket assembly 330 including a hook 332 to keep the winch pawl 320 disengaged from the gear assembly 310; and a torsion spring 340 configured to keep the winch pawl 320 engaged to the gear assembly 310.

In one implementation, the winch pawl 320 includes a slot 324, wherein the winch pawl 320 is positioned to move the slot 324 to accept the hook 332 and to disengage from the gear assembly 310, or wherein the winch pawl 320 is positioned to move the slot 324 out and away from the hook 332 and to engage the gear assembly 310. In one implementation, the winch 300 further includes a steel pin 350 having a proximal end and a distal end, wherein the distal end is inserted through the plate 334, and includes a side hole 354. In one implementation, the winch pawl 320 further includes tips 322, a first side 327, a second side 329, a rear end 328, and a pair of holes 326, wherein the steel pin 350 passes through the pair of holes 326 of the winch pawl 320, and wherein the torsion spring 340 is disposed between the first side 327 and the second side 329 of the winch pawl 320. In one implementation, the winch 300 further includes a compression spring 342 inserted through the steel pin 350 and disposed between the plate 334 and the first side 327 of the winch pawl 320, wherein the compression spring 342 is configured to push the winch pawl 320 out and away from the plate 334, when the rear end 328 is pushed down while the tips 322 of the winch pawl 320 are engaging the gear assembly 310. In one implementation, the torsion spring 340 is configured to move the rear end 328 of the winch pawl 320 up and to drop the tips 322 down to engage the gear assembly 310, when the winch pawl 320 is pushed toward the winch plate 334 while the tips 322 of the winch pawl 320 are disengaged from the gear assembly 310. In one implementation, the gear assembly 310 further includes dual-gear teeth 312 and resting surfaces 314, and wherein the tips 322 of the winch pawl 320 rest on or above the resting surface 314 when the winch pawl 320 is disengaged from the gear assembly 310, or drop on the dual-gear teeth 312 when the winch pawl 320 is engaging the gear assembly 310. In one implementation, the winch 300 further includes a spring pin 352 configured to insert into the side hole 354 of the steel pin 350 to secure the winch pawl 320 onto the plate 334.

The disclosed implementations are provided to enable any person skilled in the art to make or use the disclosure. Various modifications to these implementations will be readily apparent to those skilled in the art, and the generic principles described herein can be applied to other implementations without departing from the spirit or scope of the disclosure. Thus, it is to be understood that the description presented herein shows implementations representative of the subject matter which is broadly contemplated by the present disclosure. All features of each implementation are not necessarily required in a particular implementation. Additional variations and implementations are also possible. Accordingly, the present disclosure is not limited only to the specific implementations describe above.

1. A dual-gear winch comprising:
a winch plate;
a gear assembly coupled to the winch plate and configured to rotate with respect to the winch plate;
a support bracket assembly coupled to the winch plate, the support bracket assembly including a hook; and
a winch pawl including a slot,
wherein the winch pawl is positioned to move the slot to accept the hook and to disengage from the gear assembly,
or
wherein the winch pawl is positioned to move the slot out and away from the hook and to engage the gear assembly.

2. The dual-gear winch of claim 1, wherein the winch plate includes at least first hole and second hole.

3. The dual-gear winch of claim 2, wherein the gear assembly is coupled to the winch plate through the first hole of the winch plate and is configured to rotate with respect to the winch plate.

4. The dual-gear winch of claim 2, further comprising
a steel pin having a proximal end and a distal end,
wherein the proximal end is inserted through the second hole of the winch plate, and includes a side hole.

5. The dual-gear winch of claim 4, wherein the winch pawl further includes tips, a first side, a second side, a rear end, and a pair of holes,
wherein the steel pin passes through the pair of holes of the winch pawl.

6. The dual-gear winch of claim 5, further comprising
a compression spring inserted through the steel pin and disposed between the winch plate and the first side of the winch pawl,
wherein the compression spring is configured to push the winch pawl out and away from the winch plate,
when the rear end is pushed down while the tips of the winch pawl are engaging the gear assembly.

7. The dual-gear winch of claim 5, further comprising
a torsion spring inserted through the steel pin and disposed between the first side and the second side of the winch pawl,
wherein the torsion spring is configured to move the rear end of the winch pawl up and to drop the tips down to engage the gear assembly,
when the winch pawl is pushed toward the winch plate while the tips of the winch pawl are disengaged from the gear assembly.

8. The dual-gear winch of claim 4, wherein the support bracket assembly further includes a bracket hole, through which the steel pin passes.

9. The dual-gear winch of claim 8, further comprising
a spring pin configured to insert into the side hole of the steel pin to secure the winch pawl onto the winch plate.

10. The dual-gear winch of claim 1, wherein the gear assembly includes dual-gear teeth and resting surfaces.

11. The dual-gear winch of claim 10, wherein the winch pawl further includes tips,
which rest on or above the resting surface when the winch pawl is disengaged from the gear assembly, or
which drop on the teeth when the winch pawl is engaging the gear assembly.

12. The dual-gear winch of claim 10, wherein the gear assembly further includes mandrel holes in between the dual-gear teeth for turning the gear assembly with a winch bar.

13. A winch attached to a plate comprising:
a gear assembly coupled to and configured to rotate with respect to the plate;
a winch pawl coupled to and rotated to engage or disengage from the gear assembly;
a support bracket assembly coupled to the plate, the support bracket assembly including a hook to keep the winch pawl disengaged from the gear assembly; and
a torsion spring configured to keep the winch pawl engaged to the gear assembly.

14. The winch of claim 13, wherein the winch pawl comprising a slot,
wherein the winch pawl is positioned to move the slot to accept the hook and to disengage from the gear assembly,
or
wherein the winch pawl is positioned to move the slot out and away from the hook and to engage the gear assembly.

15. The winch of claim 13, further comprising
a steel pin having a proximal end and a distal end,
wherein the distal end is inserted through the plate, end includes a side hole.

16. The winch of claim 15, wherein the winch pawl further includes tips, a first side, a second side, a rear end, and a pair of holes,
wherein the steel pin passes through the pair of holes of the winch pawl, and
wherein the torsion spring is disposed between the first side and the second side of the winch pawl.

17. The winch of claim 16, further comprising
a compression spring inserted through the steel pin and disposed between the plate and the first side of the winch pawl,
wherein the compression spring is configured to push the winch pawl out and away from the plate,
when the rear end is pushed down while the tips of the winch pawl are engaging the gear assembly.

18. The winch of claim 16, wherein
the torsion spring is configured to move the rear end of the winch pawl up and to drop the tips down to engage the gear assembly,
when the winch pawl is pushed toward the winch plate while the tips of the winch pawl are disengaged from the gear assembly.

19. The winch of claim 16, wherein the gear assembly further includes dual-gear teeth and resting surfaces, and
wherein the tips of the winch pawl
rest on or above the resting surface when the winch pawl is disengaged from the gear assembly, or
drop on the dual-gear teeth when the winch pawl is engaging the gear assembly.

20. The winch of claim 15, further comprising
a spring pin configured to insert into the side hole of the steel pin to secure the winch pawl onto the plate.
